(19) United States
(12) Patent Application Publication
(10) Pub. No.: US 2024/0059538 A1
(43) Pub. Date: Feb. 22, 2024

(54) QUICK RELEASE DETACHABLE PLATFORM GATE

(71) Applicant: OSHKOSH CORPORATION, Oshkosh, WI (US)

(72) Inventors: Neil HARRIS, Leicester (GB); Morten ELLIS, Nottingham (GB); Sam DIXON, Leicester (GB); Scott HARRIS, Leicester (GB); Paul WILKINSON, Leicester (GB); Andrew REECE, Leicester (GB)

(21) Appl. No.: 18/235,979

(22) Filed: Aug. 21, 2023

Related U.S. Application Data
(60) Provisional application No. 63/399,232, filed on Aug. 19, 2022.

(51) Int. Cl. B66F 17/00

(52) U.S. Cl. CPC B66F 17/006

(57) ABSTRACT

A gate assembly for a safety rail on an aerial work platform includes a gate pivotally connected to the safety rail via a hinge. The hinge includes a quick release pin and is configured such that removal of the quick release pin enables separation of the gate from the safety rail.

### CROSS-REFERENCES TO RELATED APPLICATIONS

This application claims the benefit of U.S. Provisional Patent Application No. 63/399,232, filed Aug. 19, 2022, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to aerial work platforms and, more particularly, to a gate assembly that enables safe and quick removal of the gate to aid the recovery of an incapacitated operator.

Existing aerial work platforms include a top, mid and bottom rail to form the structure of the platform. A pivotable gate provides for ingress to and egress from the platform. The gate or gates typically open inward for safety reasons. In the event that an operator is incapacitated on the deck of the platform, it may be difficult to open the gate(s) inward. If this was to occur, the operator could be extracted by pulling the operator out between the mid and bottom rail on either side of the platform.

Recent platform safety rails have been provided with vertical rails as opposed to horizontal rails to prevent operators from climbing on the mid rail to gain extra height. The vertical rail structure, however, raises a potential challenge in that if an operator is incapacitated on the platform and is blocking movement of the gate, it would be difficult to extract the operator without lifting the operator over the top rail or putting the machine on its side, neither of which would be ideal.

### SUMMARY

It would thus be desirable to provide a quick release feature to enable the gate to be removed for quick and safe recovery of the operator.

A gate assembly for a safety rail on an aerial work platform includes a gate pivotally connected to the safety rail via a hinge, where the hinge includes a quick release pin, and the hinge is configured such that removal of the quick release pin enables separation of the gate from the safety rail.

In an exemplary embodiment, a safety rail for an aerial lift platform includes a first side rail, a second side rail, and a gate connected between the first and second side rails such that the first and second side rails and the gate define a safety enclosure. The gate includes top and bottom connecting plates fixed thereto, and the gate is pivotally attached to the first side rail via a hinge. The hinge includes a top support plate fixed to the first side rail, a bottom support plate fixed to the first side rail, and a quick release pin extending through the top and bottom support plates and through the top and bottom connecting plates.

An R clip may be extendable through an aperture in the quick release pin.

The hinge may be a first hinge, and the gate may further include a second hinge with a second top support plate fixed to the first side rail, a second bottom support plate fixed to the first side rail, and a second quick release pin extending through the second top and bottom support plates. The first hinge may be an upper hinge, and the second hinge may be a lower hinge.

A spring may be positioned over the quick release pin and between the top and bottom support plates.

The hinge may be a first hinge, and the gate may include two doors, where one of the two doors is pivotally attached to the first side rail via the first hinge, and the other of the two doors is pivotally attached to the second side rail via a second hinge.

The first side rail may include a plurality of vertical rails, and the second side rail may include a plurality of vertical rails.

In another exemplary embodiment, a gate assembly for a safety rail on an aerial work platform includes a gate pivotally connected to the safety rail via a hinge. The hinge includes a quick release pin, and the hinge is configured such that removal of the quick release pin enables separation of the gate from the safety rail.

In yet another exemplary embodiment, a platform for an aerial lift includes a platform floor, a safety rail, and a gate assembly coupled with the safety rail. The gate assembly includes a gate pivotally connected to the safety rail via a hinge. The hinge includes a quick release pin, and the hinge is configured such that removal of the quick release pin enables removal of the gate from the safety rail.

### BRIEF DESCRIPTION OF THE DRAWINGS

These and other aspects and advantages will be described in detail with reference to the accompanying drawings, in which:

FIG. 1 shows an exemplary aerial work platform including a safety enclosure with vertical rails;

FIG. 2 is a close-up view of an exemplary upper quick release hinge;

FIG. 3 is a close-up view of an exemplary lower quick release hinge;

FIG. 4 is an exemplary configuration with a gate including two pivotable doors; and

FIGS. 5 and 6 show a split ring and lanyard for securing the R clips.

### DETAILED DESCRIPTION

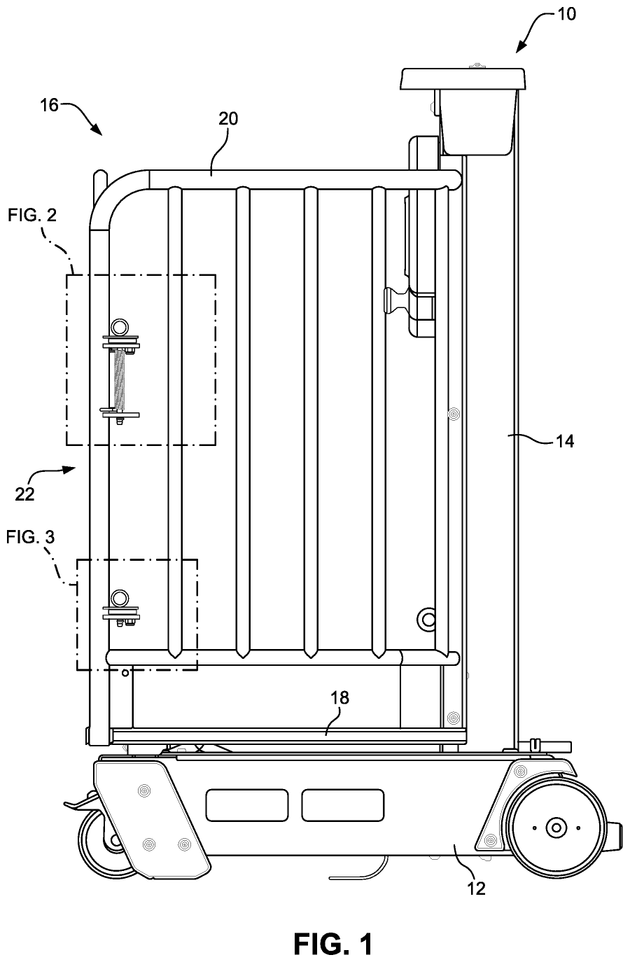

FIG. 1 shows an exemplary personnel lift 10 including a base 12 and a mast or tower 14. A work platform 16 is displaceable on the mast 14 between a lowered position and a raised position. The work platform 16 includes a platform floor 18, a safety rail 20, and a gate 22.

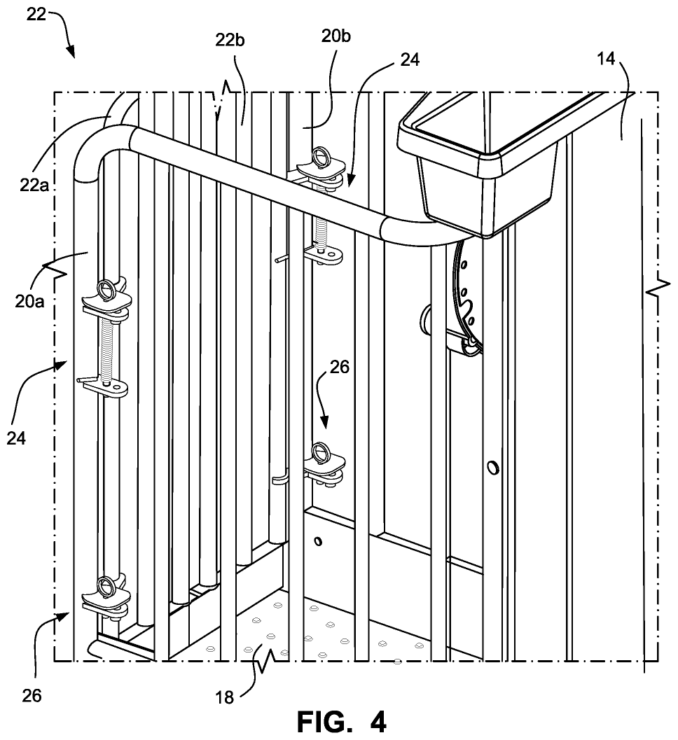

In some embodiments, with reference to FIG. 4, the safety rail 20 includes a first side rail 20a and a second side rail 20b. The gate 22 may be pivotally connected to one of the side rails 20a, 20b. In the embodiment shown in FIG. 4, the gate 22 includes two doors 22a, 22b, each respectively pivotally attached to the side rails 20a, 20b such that the gate assembly is configured for ingress and egress between the doors 22a, 22b.

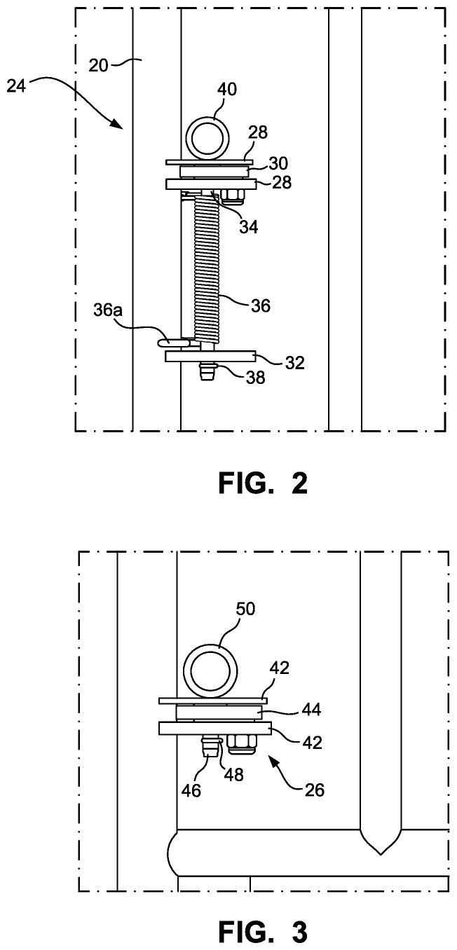

With reference to FIGS. 2 and 3, an upper hinge 24 and a lower hinge 26 enable the gate 22 to pivot inward for platform ingress and egress. The upper hinge 24 includes at least one top support plate 28 fixed to the safety rail 20 and a connecting plate 30 fixed to the gate 22 and positioned on top of the top support plate 28 (or sandwiched between two top support plates 28). The upper hinge 24 also includes a bottom support plate 32 fixed to the safety rail 20.

A quick release pin 34 extends through the top support plate(s) 28 and the connecting plate 30 and through the bottom support plate 32. A torsion spring 36 or the like is positioned over the quick release pin 34 and engages the safety rail 20. An end 36a of the spring 36 engages the safety rail 20 as shown in FIG. 2 such that the spring 36 serves to bias the gate 22 toward a closed position. That is, as the gate 22 is pivoted inward, the spring 36 is held in place and is compressed by the engagement of the end 36a with the safety rail 20. When the gate 22 is released, the spring 36 returns the gate 22 to its closed position.

A cotter pin or R clip 38 extends through an aperture in the quick release pin 34 to secure the quick release pin 34 in place. The quick release pin 34 may also be provided with a finger pull 40 to facilitate removal of the pin 34.

The lower hinge 26 includes at least one support plate 42 fixed to the safety rail 20 and a connecting plate 44 fixed to the gate 22. A second quick release pin 46 similarly includes an R clip 48 and a finger pull 50.

As shown in FIG. 4, in some embodiments, the assembly may include two upper hinges 24 and two lower hinges 26.

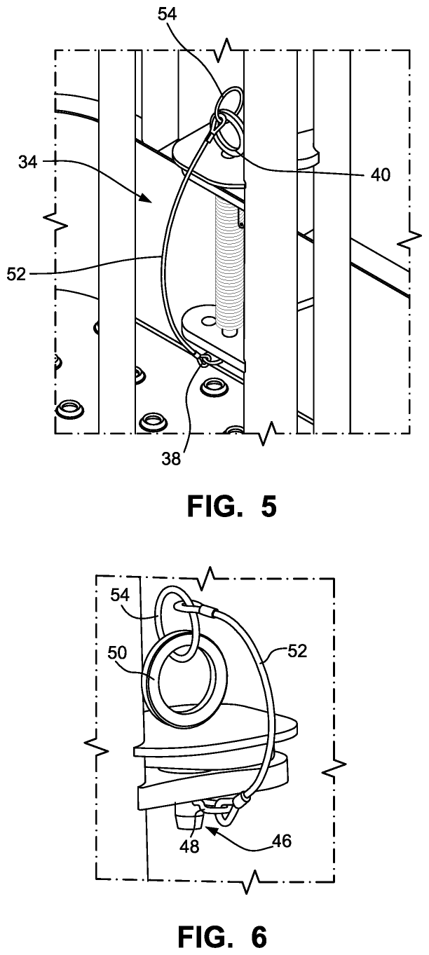

FIGS. 5 and 6 show a variation including a lanyard 52 connected between the finger pull 40 and the R clip 38 of the upper hinge 24 and a lanyard 52 connected between the finger pull 50 and the R clip 48 of the lower hinge 26 via a split ring 54 or the like. The lanyards 52 reduce the risk of the R clips 38, 48 being lost or misplaced.

In use, the hinges 24, 26 function in the same manner as existing hinges and maintain compliance with all standards. The spring 36 provides for a self-closing gate. Once the R clips 38, 48 are removed, the quick release pins 34, 46 can be readily removed from the hinges by pulling the finger pulls 40, 50 upward. Once both pins 34, 46 have been removed from the hinges, the gate 22 can be quickly removed to allow for operator recovery.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A safety rail for an aerial lift platform, the safety rail comprising:
a first side rail;
a second side rail; and
a gate connected between the first and second side rails such that the first and second side rails and the gate define a safety enclosure, the gate including top and bottom connecting plates fixed thereto, wherein the gate is pivotally attached to the first side rail via a hinge, the hinge comprising:
a top support plate fixed to the first side rail,
a bottom support plate fixed to the first side rail, and
a quick release pin extending through the top and bottom support plates and through the top and bottom connecting plates.

2. A safety rail according to claim 1, further comprising an R clip extendable through an aperture in the quick release pin.

3. A safety rail according to claim 1, wherein the hinge is a first hinge, and wherein the gate further comprises a second hinge including a second top support plate fixed to the first side rail, a second bottom support plate fixed to the first side rail, and a second quick release pin extending through the second top and bottom support plates, wherein the first hinge is an upper hinge, and wherein the second hinge is a lower hinge.

4. A safety rail according to claim 1, further comprising a spring positioned over the quick release pin and between the top and bottom support plates.

5. A safety rail according to claim 1, wherein the hinge is a first hinge, and wherein the gate comprises two doors, one of the two doors being pivotally attached to the first side rail via the first hinge, and the other of the two doors being pivotally attached to the second side rail via a second hinge.

6. A safety rail according to claim 1, wherein the first side rail comprises a plurality of vertical rails, and wherein the second side rail comprises a plurality of vertical rails.

7. A gate assembly for a safety rail on an aerial work platform, the gate assembly comprising a gate pivotally connected to the safety rail via a hinge, wherein the hinge comprises a quick release pin, and wherein the hinge is configured such that removal of the quick release pin enables separation of the gate from the safety rail.

8. A gate assembly according to claim 7, further comprising an R clip extendable through an aperture in the quick release pin, wherein the R clip prevents removal of the quick release pin from the hinge.

9. A gate assembly according to claim 7, further comprising a spring secured on the quick release pin, the spring urging the gate toward a closed position.

10. A gate assembly according to claim 7, wherein the hinge is a first hinge, and wherein the gate comprises a first door pivotally connected to one side of the safety rail via the first hinge and a second door pivotally connected to an opposite side of the safety rail via a second hinge.

11. A gate assembly according to claim 10, wherein the second hinge comprises a quick release pin.

12. A work platform for an aerial lift, the platform comprising:
a platform floor;
a safety rail; and
a gate assembly coupled with the safety rail, the gate assembly including a gate pivotally connected to the safety rail via a hinge, wherein the hinge comprises a quick release pin, and wherein the hinge is configured such that removal of the quick release pin enables removal of the gate from the safety rail.

13. A work platform according to claim 12, further comprising an R clip extendable through an aperture in the quick release pin, wherein the R clip prevents removal of the quick release pin from the hinge.

14. A work platform according to claim 12, further comprising a spring secured on the quick release pin, the spring urging the gate toward a closed position.

15. A work platform according to claim 12, wherein the hinge is a first hinge, and wherein the gate comprises a first door pivotally connected to one side of the safety rail via the first hinge and a second door pivotally connected to an opposite side of the safety rail via a second hinge.

16. A work platform according to claim 15, wherein the second hinge comprises a quick release pin.

17. A work platform according to claim 12, wherein the gate comprises top and bottom connecting plates fixed thereto, and wherein the hinge comprises:
a top support plate fixed to the safety rail,
a bottom support plate fixed to the safety rail, and
the quick release pin extending through the top and bottom support plates and through the top and bottom connecting plates.

18. A work platform according to claim 17, wherein the hinge comprises two of the top support plate, and wherein the top connecting plate is sandwiched between the top support plates.
